(19) United States
(12) Patent Application Publication
(10) Pub. No.: US 2007/0114277 A1
(43) Pub. Date: May 24, 2007

(54) Apparatus and method for commercial transactions

(75) Inventors: Phuc Ky Do, Morrisville, NC (US); Justin Monroe Pierce, Cary, NC (US)

Correspondence Address: IBM CORPORATION, PO BOX 12195, DEPT YXSA, BLDG 002, RESEARCH TRIANGLE PARK, NC, 27709, US

(73) Assignee: INTERNATIONAL BUSINESS MACHINES CORPORATION, ARMONK, NY (US)

(21) Appl. No.: 11/284,118

(22) Filed: Nov. 21, 2005

(51) Int. Cl. G06K 15/00

(52) U.S. Cl. 235/383

(57) ABSTRACT

Apparatus and methods which facilitate use of a commercial transaction system by service employees and by customer users. The system responds to the presence and motions of a user to effectuate selection of elements for the transaction—such as selection of products or services—and validation of payment.

### FIELD AND BACKGROUND OF INVENTION

Business, and particularly retail trade, has come to rely on electronic transaction processing, also known as Point of Sale or POS technology. Consumers and customers world wide have become acclimated to handling transactions with scanners that identify products or elements of commercial transactions, card and document readers of varying types that scan and validate a form of payment offered by a customer, such as credit or debit cards or bank checks or drafts.

While the state of the art at the invention of the apparatus and methods to be described here includes such capabilities, where devices of various sorts are operatively coupled to a computer system which coordinates the various steps from product or service selection through completion of the transaction, such apparatus typically uses what may be termed a “retail cluster” at each service employee location. For example, a fast food restaurant may have a front counter which divides a service employee area from a customer area. Spaced along such a counter are a plurality of sets of devices, one for each service employee workstation. A grocery store check out area may have a number of lanes, each with a cashier station and retail cluster. A clothing store may have a sales counter with a number of workstations, each a retail cluster.

### SUMMARY OF THE INVENTION

With the foregoing in mind, it is one purpose of this invention to simplify the apparatus used in supporting commercial transactions in businesses. In realizing this purpose, the number of devices which must communicate with a supporting computer system is reduced by employing a display/sensor technology which differs inventively from prior systems.

Yet another purpose of this invention is to facilitate use of the commercial transaction system and method by service employees and by customer users. In realizing this purpose of this invention, methods are implemented in which the system responds to the presence and motions of a user to effectuate selection of elements for the transaction—such as selection of products—and validation of payment.

### BRIEF DESCRIPTION OF DRAWINGS

Some of the purposes of the invention having been stated, others will appear as the description proceeds, when taken in connection with the accompanying drawings, in which:

FIG. 1 is a schematic elevation illustration of a business establishment in which the apparatus and methods of this invention are implemented;

FIG. 2 is an illustration of one form of interface as viewed from the perspective of a service employee working with the system;

FIG. 3 is an illustration of one form of interface as viewed from the perspective of a customer working with the system;

FIG. 4 is an illustration of one form of computer readable media bearing program code generated to implement this invention when executing on a computer system and linked optical transducer.

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

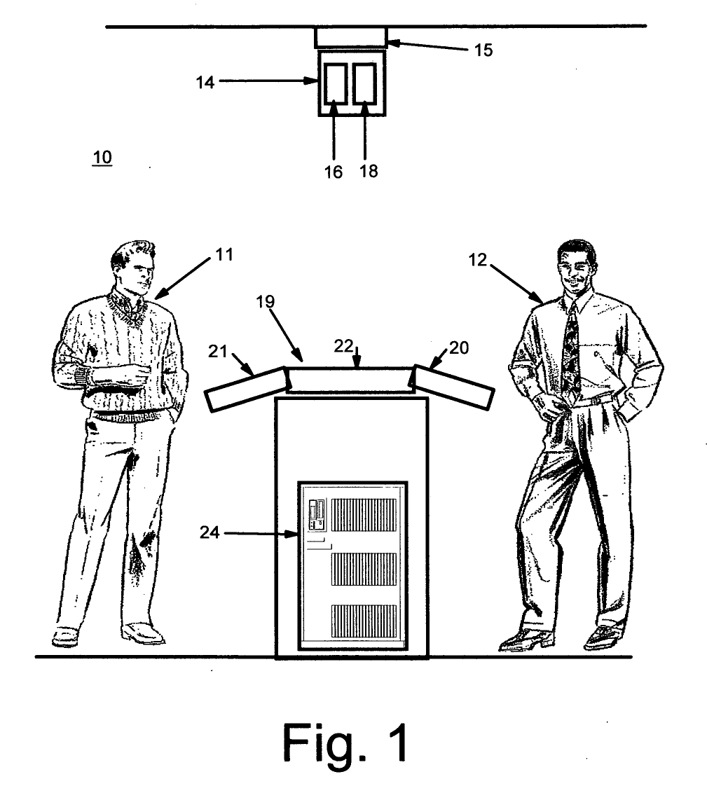

Referring now to FIG. 1, that view shows a representative retail establishment 10 in which the present invention is implemented. A customer user 11 interacts with a service employee user 12 and with the system of the present invention, now to be described. The knowledgeable reader will understand that what is illustrated as only representative, as the specifics of any given retail environment are subject to wide variation as may be chosen my store owners or designers. It is the intention of this invention that it find usefulness in a wide range of establishments, some of which will be additionally described hereinafter.

In accordance with specific features of this invention, the establishment has an optical transducer 14. The transducer 14 is shown as mounted on a ceiling track 15, where it may be mounted for movement along the track (for purposes made more clear hereinafter) or fixed in position. The transducer includes a projector 16 and a camera 18. The transducer 14 projects, with the projector 16, an images or images of elements of a commercial transaction. That is, the images may be of products being offered, text descriptions of products or services, or such other matter as a merchant may choose to provide to prospective customers, of which more will be said later. The transducer views, with the camera 18, the presence of users 11, 12 and motions made by them relative to images projected.

The images projected by the transducer 14 are directed to a projection surface 19 which displays to a user 11, 12 an image projected from the transducer 14. Preferably, and as shown, the projection surface 19 is disposed between a customer area and a service employee area and defines a boundary between the areas. The projection surface 19 further defines a service employee area 20 positioned for visibility to a service employee, a customer area 21 positioned for visibility to a customer, and a common area 22 disposed between the service employee area and the customer area and visible to both a service employee 11 and a customer 12. The projection surfaces are non-touch sensitive. That is, the surfaces are simply flat or curved surfaces of a plain material serving as an appropriate “screen” on which an image may be projected.

In accordance with the present invention, a computer system 24 is operatively coupled to the optical transducer to perform a number of operations. The computer system 24 drives the projector 16 to control images projected onto the surface 19 which illustrate elements of a commercial transaction; responds to the camera 18 viewing the presence of and actions by a user motioning at illustrated elements; and records and effectuates a commercial transaction with the customer user regarding elements selected by the user's motions.

More particularly, the computer system 24, under the direction of the owner of manager of the retail establishment, will cause the projection of images, such as the menu images of fast foods items which can be selected, or text descriptions of other goods and/or services such as subscription terms for cellular telephone service. Such elements of a commercial transaction may be projected onto the common area 22 for simultaneous viewing by the employee 11 and customer 12. Either user may indicate selection of a display item or good or service by pointing to the image, in a manner similar to what are known as “touch screens” as used in prior art POS systems. With the camera 18 viewing the common area 22, such a motion is recognized and recorded.

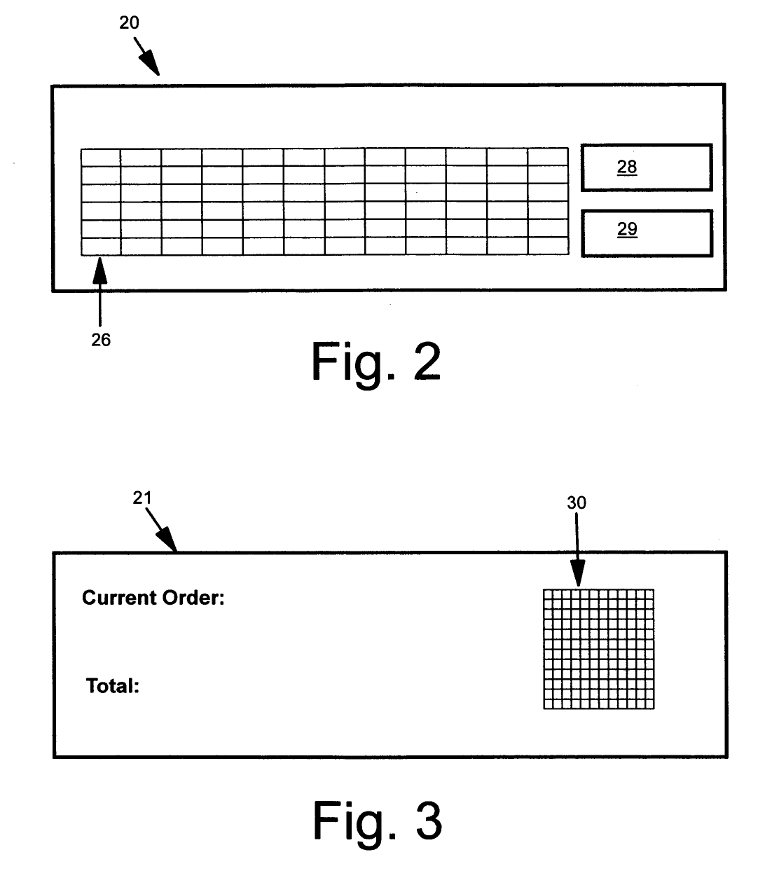

The present invention contemplates that the images displayed may be accommodated to the needs of the different users. More particularly, the image projected onto the employee viewing area 20 for viewing by the employee 11 may be a cashier interface, as shown in FIG. 2. There, the display may include “buttons” 26 projected to enable the employee to key in purchases and special areas for scanning and validating a form of payment offered by a customer user. For example, these special areas may include a check scanning area 28 and a card scanning area 29. These areas, when scanned and recorded in the computer system 24, replace the more conventional magnetic strip or optical character recognition readers for credit or debit cards and bank checks or drafts. The technology for validating a charge or payment by such instruments is well known and need not be disclosed here in detail.

The image projected onto the customer viewing area 21 may be as shown in FIG. 3. There, provision is made for showing a running total of purchases made and a list of elements of the commercial transaction. Additionally, a special projection area 30 may be included in which the surface has a material which limits the angle of view at which projected information is visible, such as a polarizing material or a material having structural “blinders” within it which restrict viewing. This area may receive a projected image of a keypad, enabling a customer user to privately enter a code such as a personal identification number (PIN) necessary to some debit card transactions. As will be apparent, the images projected to any portion of the surface 19 may be chosen by the establishment designer or business management to take any desired form. What is illustrated is solely an illustrative example.

In some circumstances, the design of a retail location may involve the use of an extended counter or the like along which a customer moves form station to station in compiling an order. One such environment might be a sandwich assembly line, where the product being prepared is passed from service employee to service employee, each of whom adds an ingredient selected by the customer at the respective workstation. In such an environment, the optical transducer may move along the ceiling mounted track so that the display, while changing, moves with the customer. Alternatively, a plurality of optical transducers may be provided, with the computer system monitoring the progress of the customer and progressively advancing the display, or a system of mirrors or the like which control the direction of a projected image may be used with a single optical transducer.

As will be understood from the description to this point, the present invention contemplates methods of operation in commercial transactions which implement a series of steps. Such methods include projecting from an optical transducer 14 onto a viewing surface 19 an image illustrating elements of a commercial transaction; capturing with the optical transducer 14 an image of a user 11, 12 viewing the projected image; responding to a captured image of a user by distinguishing motions of the user indicative of selection of an illustrated element; and initiating and completing a commercial transaction based upon the user selecting an illustrated element. The methods include projecting a service employee image onto a viewing surface visually accessible to a service employee user while projecting a customer image onto a viewing surface visually accessible to a customer user; projecting as the customer image indicia indicating the progress of a current commercial transaction; projecting into defined areas images representative of defined goods and services offered to a consumer; sensing the presence of a user and detecting motions of the user pointing to defined areas of projected images; and scanning and validating a form of payment offered by a customer user.

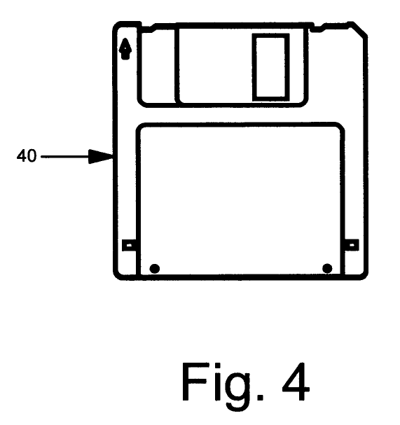

The apparatus and methods here described are implemented through the production of computer executable program code which is stored on a computer readable medium 40 (FIG. 4) and provided to be deployed to and executed on the computer system 24. Such code, when executing on a computer system and linked optical transducer, causes the projection from the optical transducer onto a viewing surface of an image illustrating elements of a commercial transaction; the capture with the optical transducer an image of a user viewing the projected image; and a response to a captured image of a user which distinguishes motions of the user indicative of selection of an illustrated element. The system thus initiates and completes a commercial transaction based upon the user selecting an illustrated element.

In the drawings and specifications there has been set forth a preferred embodiment of the invention and, although specific terms are used, the description thus given uses terminology in a generic and descriptive sense only and not for purposes of limitation.

What is claimed is:

1. Apparatus comprising:
an optical transducer which projects images illustrating elements of a commercial transaction and views an interaction between a user and a projected image;
a projection surface positioned relative to said optical transducer and which displays to the user an image projected onto said surface by said optical transducer;
a computer system operatively coupled to said optical transducer and which:
controls images projected onto said surface which illustrate elements of a commercial transaction;
responds to said optical transducer viewing the presence of and actions by a user motioning at illustrated elements; and
records and effectuates a commercial transaction with the user regarding elements selected by the user's motions.

2. Apparatus according to claim 1 wherein said optical transducer comprises a projector and a camera.

3. Apparatus according to claim 1 wherein said optical transducer and said projection surface are disposed in a retail business establishment.

4. Apparatus according to claim 3 wherein said projection surface is disposed between a customer area and a service employee area and defines a boundary between the areas.

5. Apparatus according to claim 4 wherein said projection surface defines a service employee area positioned for visibility to a service employee and a customer area positioned for visibility to a customer.

6. Apparatus according to claim 5 wherein said projection surface defines a common area disposed between said service employee area and said customer area and visible to both a service employee and a customer.

7. Apparatus according to claim 5 wherein said optical transducer and said computer system cooperate to project onto said customer area indicia indicating the progress of a current commercial transaction.

8. Apparatus according to claim 1 wherein said optical transducer and said computer system cooperate to sense the presence of a user and to detect motions of the user pointing to defined areas of projected images.

9. Apparatus according to claim 8 wherein said optical projector and said computer system cooperate to project onto defined areas images representative of defined goods and services offered to a consumer.

10. Apparatus according to claim 1 wherein said optical transducer and said computer system cooperate to scan and validate a form of payment offered by a customer user.

11. Method comprising:
projecting from an optical transducer onto a viewing surface an image illustrating elements of a commercial transaction;
capturing with the optical transducer an image of a user viewing the projected image;
responding to a captured image of a user by distinguishing motions of the user indicative of selection of an illustrated element;
initiating and completing a commercial transaction based upon the user selecting an illustrated element.

12. Method according to claim 11 further comprising projecting a service employee image onto a viewing surface visually accessible to a service employee user while projecting a customer image onto a viewing surface visually accessible to a customer user.

13. Method according to claim 12 further comprising projecting as the customer image indicia indicating the progress of a current commercial transaction.

14. Method according to claim 11 further comprising disposing the optical transducer and viewing surface in a retail business establishment.

15. Method according to claim 14 further comprising projecting into defined areas images representative of defined goods and services offered to a consumer.

16. Method according to claim 14 further comprising scanning and validating a form of payment offered by a customer user.

17. Method according to claim 11 further comprising sensing the presence of a user and detecting motions of the user pointing to defined areas of projected images.

18. Apparatus comprising:
computer readable media; and
computer readable and executable code stored on said media accessibly to a computer system;
said code when executing on a computer system and linked optical transducer:
projecting from an optical transducer onto a viewing surface an image illustrating elements of a commercial transaction;
capturing with the optical transducer an image of a user viewing the projected image;
responding to a captured image of a user by distinguishing motions of the user indicative of selection of an illustrated element;
initiating and completing a commercial transaction based upon the user selecting an illustrated element.

19. Method comprising:
producing computer executable program code;
storing the produced program code on a computer readable medium; and
providing the program code to be deployed to and executed on a computer system;
the program code comprising instructions which, when executing on the computer system and linked optical transducer:
projecting from an optical transducer onto a viewing surface an image illustrating elements of a commercial transaction;
capturing with the optical transducer an image of a user viewing the projected image;
responding to a captured image of a user by distinguishing motions of the user indicative of selection of an illustrated element;
initiating and completing a commercial transaction based upon the user selecting an illustrated element.
